(19) United States
(12) Patent Application Publication
(10) Pub. No.: US 2004/0115015 A1
(43) Pub. Date: Jun. 17, 2004

(54) Apparatus for making dental inlays and the like

(76) Inventors: Lennart Sjostedt, Aryd (SE); Andreas Dahr, Hovas (SE)

Correspondence Address: HARNESS, DICKEY & PIERCE, P.L.C., P.O. BOX 8910, RESTON, VA, 20195, US

(21) Appl. No.: 10/415,150

(22) PCT Filed: Oct. 25, 2001
(86) PCT No.: PCT/SE01/02332

(30) Foreign Application Priority Data
Oct. 26, 2000 (SE) 0003896-8

(51) Int. Cl. B23C 3/00; B23C 1/18; B23C 3/04; B23C 1/04

(52) U.S. Cl. 409/96; 409/165; 409/192; 409/203

(57) ABSTRACT

An apparatus (1) for making dental inlays or the like by copy milling a blank (7) based on an original (4) comprises a first spindle (3), which is adpated to hold the original (4) and a second spindle (5), which is aligned with the first spindle (2) and adapted to hold the blank (7). A first sensing unit (8) is adapted to scan the original (4) with a probe (9), and a first milling unit (10) is adapted to mill the blank (7) by means of a shank-end mill (11) to form a dental inlay or the like whose shape corresponds to that of the orignal (4) scanned by the probe (9). A second sensing unit (13) is adapted to carry out a rough scan of the original (4) before the first sensing unit (8) by means of a rotatable disc (14), and a second milling unit (15) is adapted to machine the blank (7), while the disc (14) scans the original (4), by means of a milling disc (16) whose size corresponds to that of the disc (14) to create a shape which roughly corresponds to that of the original (4).

### FIELD OF THE INVENTION

The present invention relates to an apparatus for making dental inlays or the like by copy milling a blank based on an original, for example in the form of an impression of a tooth cavity to be filled, said apparatus comprising a rotatable first spindle, which is adapted to hold the original with the aid of a fixing means arranged at the end of the spindle; a rotatable second spindle, which is aligned with the first spindle and adapted to hold the blank with the aid of a fixing means arranged at the end of the second spindle, the operation of said spindles being synchronized; a first sensing unit, which is adapted to scan the original with a probe; and a first milling unit, which is adapted to mill the blank, while the probe scans the original, by means of a shank-end mill to form a dental inlay or the like whose shape corresponds to that of the original scanned by the probe, the first sensing unit and the first milling unit being mounted on a common first holder, which is pivotalbe about a first pivot axis that is parallel to the spindle axis.

### BACKGROUND ART

An apparatus of the type mentioned by way of introduction is known from PCT application No. WO96/05781. Preferably, it is used to make dental inlays, but can also be used to make, for example, artificial crowns.

In current tooth filling, a dental inlay adapted to the form of the prepared tooth is often attached thereon by means of an adhesive cement. Preferably, the inlay is adapted to the right form by copy-milling a ceramic blank while automatically scanning an impression of a prepared tooth. In this context, it is, of course, important to achieve a high degree of accuracy of form to avoid the formation of cavities between the prepared tooth and the dental inlay, as well as to consider, when making the dental inlay, that the sides of the dental inlay intended to be cemented and that, after attachment, there should be a polishing margin on the side of the dental inlay facing the teeth of the opposite jaw which the dentist can use for the final adjustment.

It will be appreciated that allowing the entire process, including preparing a damaged tooth, making an impression thereof, making a original for copy-milling, milling a dental inlay based on the original, attaching adjustment thereof, to be carried out in one single treatment session is a major advantage. To make this possible, an apparatus is required which can be operated by any ordinary dentist and which very quickly, reliably and largely automatically produces the desired dental inlay.

### OBJECT OF THE INVENTION

The prior-art device has apparent drawbacks as far as user-friendless and, particularly, speed are concern. An object of the invention is therefore to obviate these drawbacks.

### SUMMARY OF THE INVENTION

According to the invention, this object is achieved by means of an apparatus of the type mentioned by way of introduction by a second sensing unit being adapted to carry out a rough scan of the original before the first sensing unit with the aid of a rotatable disc, and by a second milling unit being adapted to machine the blank, while the disc scans the original, by means of a milling disc whose size corresponds to that of the disc to create a shape which roughly corresponds to that of the orginal, the second sensing unit and the second milling unit being mounted on a common second holder, which is pivotable about a second pivot axis.

Owing to the second sensing unit and the second milling unit associated therewith, said milling unit being intended especially for quick machining, the production time is considerably reduced as is the need for maintaining the apparatus, since the life of the shank-end mill of the first milling unit increase significantly as it only has to perform the fine mmilling, the second milling unit having performed the rough-machining.

In the inventive apparatus, the second pivot axis is preferably parallel to the first pivot axis, the two holders being arranged on either side of the two mutually aligned spindles.

This solution allows, in a simple manner, simultaneous machining of the blank from two sides, more specifically, a preparatory rough-machining carried out by the second milling unit on one side of the blank and a final finishing of the rough-machined surface on the other side of the blank.

Moreover, in one embodiment of the inventive apparatus, the first and second spindles are preferably rigidly connected to each other and mounted in a common bearing housing.

This solution ensures, in a particularly simple manner, both the necessary synchronization between the two spindles and the similarly necessary relative alignment of these.

In the latter embodiment of the inventive apparatus, the bearing housing is preferably displaceable together with the two spindles along the spindle axis.

This solution, too, aims at ensuring a maintained synchronization between the two spindles and allows, in a simple manner, rotational driving thereof by means of a motor, which is integrated into the bearing housing and displaceable together with said bearing housing.

Preferably, the first holder comprises a joint with a third pivot axis which is parallel to the first pivot axis and extends perpendicularly to the longitudinal axes of the shank-end mill and the probe, and about which the first sensing unit and the first milling unit are pivotable

Providing a joint in the first holder in this manner creates a further degree of freedon for the inventive apparatus, allowing, inter alia, manufacture of dental inlays or the like with more or less undercut surfaces.

Futhermore, in the inventive apparatus, the first and second holders are each preferably mounted in a vertically arranged, circular-cylindrical bearing housing, each bearing housing being fixed, by means of screws that are radially inserted in the repective bearing housings, to a corner of a vertically oriented sectional element forming the rear of the apparatus.

By fixing said bearing housings in a fixed corner of a precision manufactured sectional element, the mounting of the apparatus is greatly facilitated, since no readjustment is required with this mode of mounting.

Finally, in the inventive apparatus, the rotation of the milling disc is caused by a driving belt, which runs on a drive roller, the rotational axis of which is aligned with the second pivot axis.

An advantage of this solution is that it reduces the risk of undersirable vibrations being transferred to the second milling unit, thus improving the possibilities of obtaining a high degree of accuracy.

### BRIEF DESCRIPTION OF THE DRAWINGS

A preferred embodiment of the inventive apparatus will be described in more detail below with reference to the accompanying drawings, in which:

FIG. 1 is a perspective front view from the right side of the apparatus;

FIG. 2 is a perspective front view from the left side of the apparatus;

FIG. 3 is a perspective rear view from the right side of the apparatus;

FIG. 4 is a perspective rear view from the left side of the apparatus; and

FIG. 5 is a top plan view of the apparatus.

### DESCRIPTION OF AN EMBODIMENT

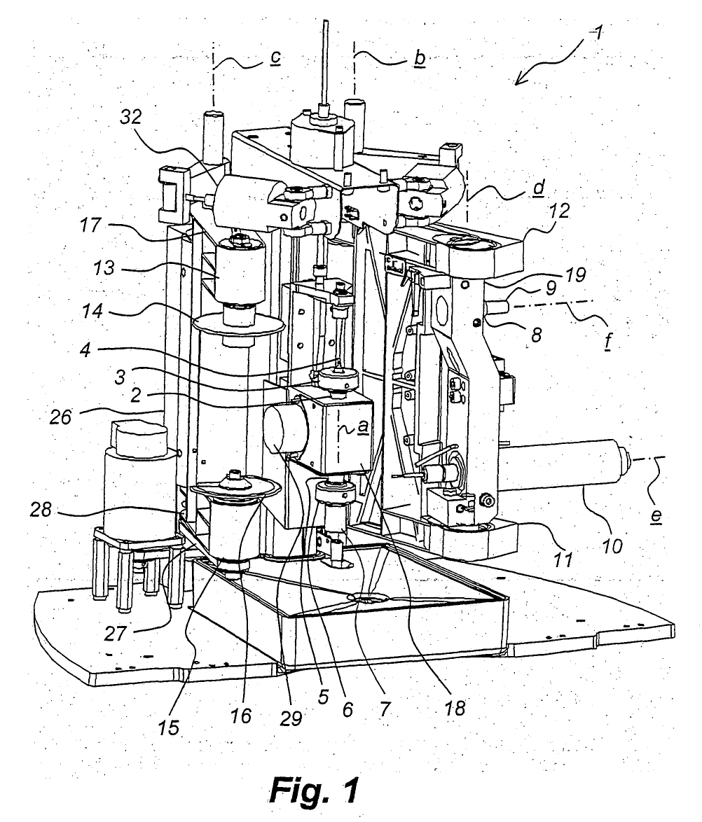

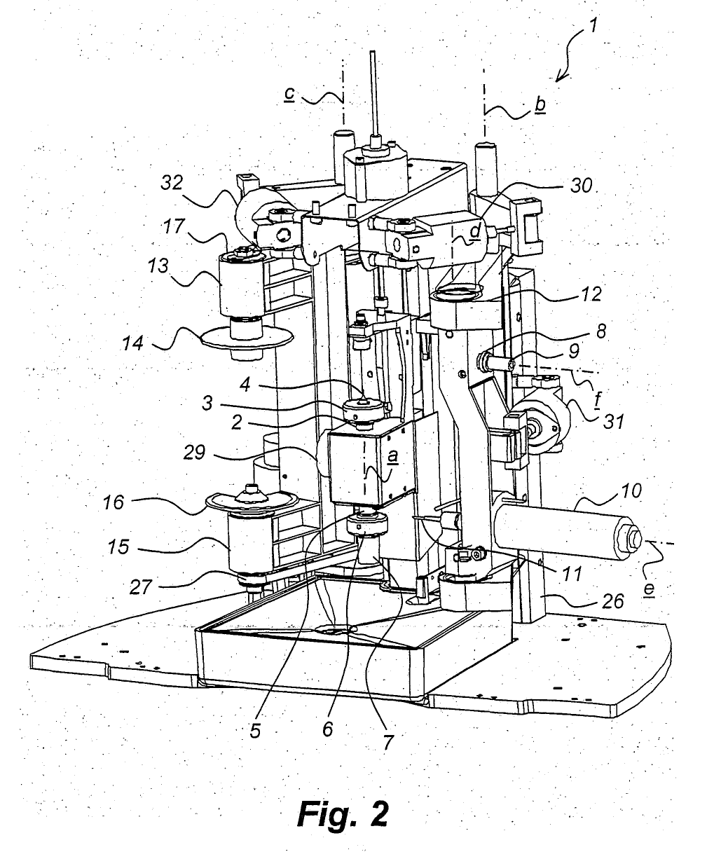

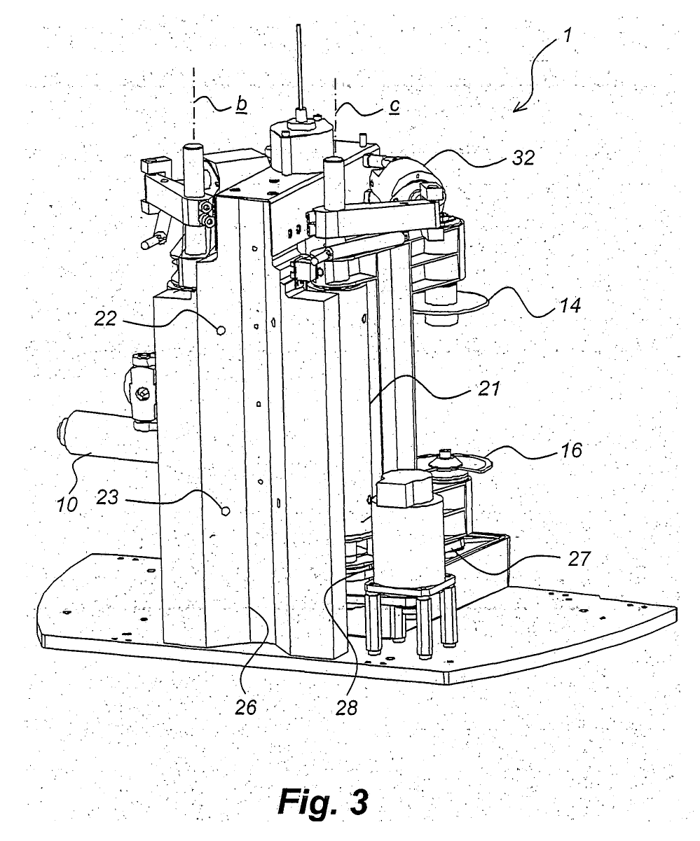

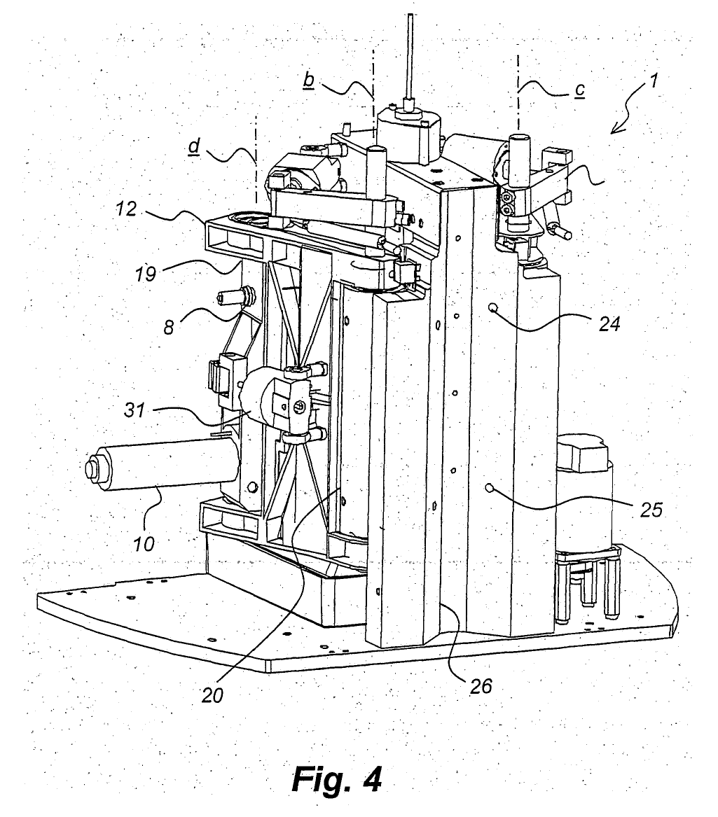

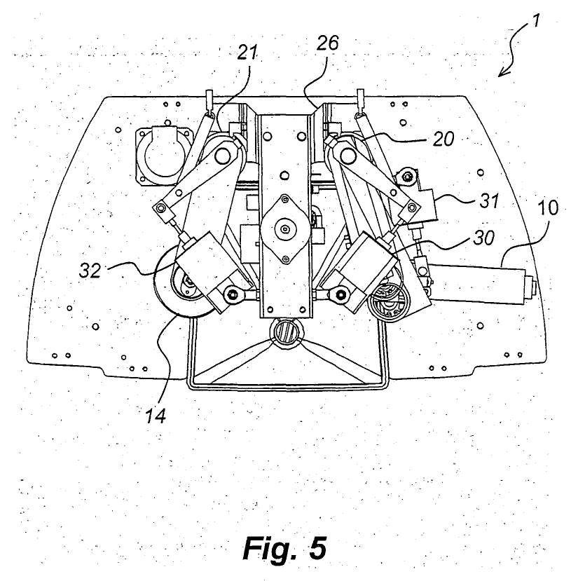

The same reference numerals are used throughout to designate corresponding parts of the apparatus illustrated in FIGS. 1-5. The apparatus 1 is intended for making dental inlays of the type described by way of introduction, which is well known to a person skilled in the art. Thus, no detailed description of such a dental inlay, the production of an inlay original or the attachment of the inlay to a prepared tooth by means of an adhesive cement is required.

Some of the parts that are suggestive of a prior-art apparatus (WO96/05781) are a rotatable first spindle 2, which is adapted to hold the original 4 with the aid of a fixing means 3 arranged at the end of the spindle 2, and a rotatable second spindle 5, which is aligned with the first spindle 2 and adapted to hold the blank 7 with the aid of a fixing means 6.

Other parts are a first sensing unit 8, which is adapted to scan the original 4 with a probe 9, and a first milling unit 10 which is adapted to mill the blank 7, while the probe 9 scans the original 4, by means of a shank-end mill 11 to form a dental inlay or the like whose shape corresponds to that of the original 4 scanned by the probe 9. The first sensing unit 8 and the first milling unit 10 are mounted on a common first holder 12, which is pivotable about a first pivot axis b that is parallel to the spindle axis a.

Unlike the prior-art apparatus, the inventive apparatus also comprises a second sensing unit 13, which is adapted to carry out a rough scan of the original 4 before the first sensing unit 8 by means of a rotatable disc 14. Moreover, it comprises a second milling unit 15, which is adapted to machine the blank 7, while the disc 14 scans the original 4, by means of a milling disc 16 whose size corresponds to that of the disc 14 to create a shape which roughly corresponds to that of the original 4 but exceeds it in terms of size. The second sensing unit 13 and the second milling unit 15 are mounted on a common second holder 17, which is pivotable about a second pivot axis c.

As shown, the second pivot axis c is parallel to the first pivot axis b, and the two holders 12, 17 are arranged on either side of the two mutually aligned spindles 2, 5.

The spindles 2, 5 are adapted to be rotationally driven in a synchronous manner and, in the embodiment shown, this is achieved by the first and second spindles 2, 5 being rigidly connected to each other and mounted in a common bearing housing 18. The bearing housing 18 is displaceable along the spindle axis a, and since the two spindles are moved simultaneously with the bearing housing, displacement of the sensing units 8, 13 and the milling units 10, 15 in relation to the original 4 and the blank 7 is made possible.

The first holder 12 has a joint 19 with a third pivot axis d that is parallel to the first pivot axis b and extends perpendicularly to the longitudinal axes e, f of the shank-end mill 11 and the probe 9 and about which the first sensing unit 8 and the first milling unit 10 are pivotable to allow, by intermediary of a pendulating motion about the pivot axis d and unlike the prior-art apparatus mentioned above, the formation of large cavities in the blank 7.

The first and second holders 12, 17 are each mounted in a vertically arranged, circular-cylindrical bearing housing 20, 21, each bearing housing being fixed, by means of screws 22-25 that are radially inserted in the respective bearing housings 20, 21, to a corner of a vertically oriented sectional element 26 forming the rear of the apparatus. This means that the bearings housings 20, 21 and the holders mounted therein always assume a predefined position in relation to the sectional element 26 and in relation to the two spindles 2, 5, since the sectional element 26 is used also to support the bearing housing 18 in which these are mounted.

As shown, the rotation of the milling disc 16 is caused by a driving belt 27, which runs on a drive roller 28, the rotational axis of which coincides with second pivot axis (c). The rotation of the spindles 2, 5 is caused by a motor 29, which is mounted on the bearing housing 18 holding the spindles 2, 5. The pivoting of the first holder 12 about the axis b is achieved by means of a first linear unit 30, and the pivoting about the joint 19 of the first holder 17 about the second pivot axis c is achieved by means of a third linear unit designated 32.

It will be apparent to those skilled in the art that the embodiment of the inventive apparatus described above can be varied mechanically in various ways within the scope of th claims. It will also be apparent to the person skilled in the art that the inventive apparatus is suitably controlled by means of a computer (not shown) and that the sensing units suitably operate electronically in co-operation with an electically conductive original 4.

1. An apparatus for making dental inlays or the like by copy-milling a blank (7) based on an original (4), for example in the form of an impression of a tooth cavity to be filled, said apparatus comprising a rotatable first spindle (2), which is adapted to hold the original (4) with the aid of a fixing means (3) arranged at the end of the spindle (2); a rotatable second spindle (5), which is aligned with the first spindle (2) and adapted to hold the blank (7) with the aid of a mounting means (6) arranged at the end of the second spindle (5), the operation of said spindles (2, 5) being synchronized; a first sensing unit (8), which is adapted to scan the original (4) with a probe (9); and a first milling unit (10), which is adapted to mill the blank (7), while the probe (9) scans the original (4), by means of a shank-end mill (11) to form a dental inlay or the like whose shape corresponds to that of the original (4) scanned by the probe (9), the first sensing unit (8) and the first milling unit (10) being mounted on a common first holder (12), which is pivotable about a first pivot axis (b) that is parallel to the spindle axis (a), c h a r a c t e r i s e d in that a second sensing unit (13) is adapted to carry out a rough scan of the original (4) before the first sensing unit (8) by means of a rotatable disc (14), and that a second milling unit (15) is adapted to machine the blank (7), while the disc (14) scans the original (4), by means of a milling disc (14) to form a shape which roughly corresponds to that of the original (4), the second sensing unit (13) and the second milling unit (15) being mounted on a common second holder (17), which is pivotable about a second pivot axis (c).

2. An apparatus according to claim 1, c h a r a c t e r i s e d in that the second pivot axis (c)is parallel to the first pivot axis (b), the two holders (12, 17) being arranged on either side of the two mutually aligned spindles (2, 5).

3. An apparatus according to claim 1 or 2, c h a r a c t e r i s e d in that the first and second spindles (2, 5) are rigidly connected to each other and mounted in a common bearing housing (18).

4. An apparatus according to claim 3, c h a r a c t e r i s e d in that the bearing housing (18) is displacement together with the two spindles (2, 5) along the spindle axis (a).

5. An apparatus according to any one of claims 1-4, c h a r a c t e r i s e d in that the first holder (12) has a joint (19) with a third pivot axis (d), which is parallel to the first pivot axis (b) and extends prependicularly to the longitudinal axes (e, f) of the shank-end mill (11) and the probe (9) and about which the first sensing unit (8) and the first milling unit (10) are piovitable.

6. An apparatus according to any one of claims 1-5, c h a r a c t e r i s e d in that the first and second holders (12, 17) each are mounted in a vertically arranged, circular-cylindricl bearing housing (20, 21), each bearing housing (20, 21) being fixed, by means of screws (22-25) that are radially inserted in the respective bearing housings (20, 21), to a corner of a vertically oriented sectional element (26) forming the rear of the apparatus.

7. An apparatus according to any one claims 1-6, c h a r a c t e r i s e d in that the rotation of the milling disc (16) is caused by a driving belt (27); which runs on a drive roller (28), the rotational axis of which coincides with the second pivot axis (c).
